(19) United States
(12) Patent Application Publication
(10) Pub. No.: US 2010/0304198 A1
(43) Pub. Date: Dec. 2, 2010

(54) ELECTRODE ASSEMBLY FOR SECONDARY BATTERY AND METHOD OF MANUFACTURING THE SAME

(75) Inventors: Changbum Ahn, Suwon-si (KR); Jeongsoon Shin, Suwon-si (KR); Youngbae Sohn, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/649,111

(22) Filed: Dec. 29, 2009

Related U.S. Application Data
(60) Provisional application No. 61/181,862, filed on May 28, 2009.

(51) Int. Cl. H01M 6/10; B65H 81/00

(52) U.S. Cl. 429/94; 156/184

(57) ABSTRACT

An electrode assembly for a secondary battery and a method of manufacturing the same are disclosed. The electrode assembly includes a first separator wound to form a plurality of stacked first separator members; a second separator wound with the first separator to form a plurality of stacked second separator members to be respectively positioned between the first separator members; and a plurality of electrode members positioned between the first separator members and the second separator members. An inner surface of one of the first separator members positioned at the innermost side and an inner surface of one of the second separator members positioned at the innermost side face each other.

### DETAILED DESCRIPTION OF THE INVENTION

1. Technical Field

The present invention relates to an electrode assembly for a secondary battery and a method of manufacturing the same.

2. Background Art

A secondary battery is generally manufactured by accommodating an electrode assembly having a positive electrode plate, a negative electrode plate, and a separator interposed therebetween into an exterior case together with an electrolyte.

In a high capacity secondary battery, a wound electrode assembly including a plurality of unit electrodes and separators is used. In this type electrode assembly, when the number of winding increases, it is not easy to exactly arrange the unit electrodes by interposing the separators therebetween.

### Technical Problem

The present invention provides an electrode assembly having a structure in which entire unit electrodes are exactly arranged and a method of manufacturing the same.

### Technical Solution

In accordance with an aspect of the present invention, there is provided an electrode assembly including: a first separator wound to form a plurality of stacked first separator members; a second separator wound with the first separator to form a plurality of stacked second separator members to be respectively positioned between the first separator members; and a plurality of electrode members respectively positioned between the first separator members and the second separator members, wherein an inner surface of one of a the first separator members positioned at the innermost side and an inner surface of one of the second separator members positioned at the innermost side face each other.

According to another aspect of the present invention, there is provided a secondary battery including the electrode assembly as described above.

According to still another aspect of the present invention, there is provided a method of manufacturing an electrode assembly, including feeding a first separator and a second separator from both sides to a winding center; and winding the first separator and the second separator about the winding center.

### ADVANTAGEOUS EFFECT

The above-mentioned electrode assembly and method enable the aspect of the present invention to be achieved. Since the electrode assembly according to the present invention has a wound structure in which inner surfaces of the two separators face each other, the electrode members positioned between the separators can be exactly arranged.

### DETAILED DESCRIPTION FOR CARRYING OUT THE INVENTION

Hereinafter, embodiments of the present invention will be described in detail with reference accompanying drawings.

FIG. 1 is a perspective view illustrating a secondary battery including an electrode assembly according to an embodiment of the present invention. Referring to FIG. 1, a secondary battery 10 is a pouch type secondary battery and includes a pouch case 20 and an electrode assembly 100 to be accommodated in the pouch case 20.

The pouch case 20 includes a body 22 and a cover 24. The body 22 includes an accommodating portion 22a to accommodate the electrode assembly 100 and a sealing member 23 extending to the outside of the accommodating portion 22a. The cover 24 is integrally coupled to one side of the sealing member 23. After the electrode assembly 100 is accommodated in the accommodating portion 22a of the body 22, the body 22 and the cover 24 contact closely with each other and then the sealing member 23 is thermally welded.

FIG. 2 is a schematic view illustrating the electrode assembly in FIG. 1. Referring to FIGS. 1 and 2, the electrode assembly 100 includes a first separator 110, a second separator 120, and a plurality of electrodes 130.

The first separator 110 is wound in a direction (counterclockwise from the center when viewing the drawings). The first wound separator 110 includes a plurality of first stacked separator members 111a, 111b, 111c, and 111d and a plurality of first connectors 112a, 112b, 112c, and 112d to connect the first separator members 111a, 111b, 111c, and 111d to each other. Each of first separator members 111a, 111b, 111c, and 111d separates two electrodes 130 positioned at both sides thereof. An outer end 110c of the first separator 110 is attached to the outer circumferential surface of the second separator 120 with a sealing tape 113. The first separator 110 has a plurality of fine porosities through which lithium ions migrating between electrodes 130 pass. The first separator 110 may be made of a polymer such as polyethylene (PE) or polypropylene (PP).

The second separator 120 and the first separator 110 are wound in a direction (counterclockwise from the center when viewing in the drawings) in alternating fashion. The second wound separator 120 includes a plurality of second stacked separator members 121a, 121b, 121c, and 121d and a plurality of second connectors 122a, 122b, 122c, and 122d to connect the second separator members 121a, 121b, 121c, and 121d to each other. The second separator members 121a, 121b, 121c, and 121d are positioned between the first separator members 111a, 111b, 111c, and 111d, and the second connectors 122a, 122b, 122c, and 122d are positioned between the first connectors 112a, 112b, 112c, and 112d. Due to this structure, the first separator members 112a, 112b, 112c, and 112d of the first separator 110 and the second separator members 121a, 121b, 121c, and 121d of the second separator 120 are alternatively positioned in a stack form. Each of the second separator members 121a, 121b, 121c, and 121d separates the two electrodes 130 positioned at both sides thereof. An inner surface 120a of the second separator member 121a positioned innermost among the second separator members 121a, 121b, 121c, and 121d faces to an inner surface 110a of the first separator member 111a positioned innermost among the first separator members 111a, 111b, 111c, and 111d. An outer end 120c of the second separator 120 is attached to outer surfaces 110d of the first separator 110 with a sealing tape 123. The second separator 120 has a plurality of fine porosities through which lithium ions migrating between electrodes 130 pass. The second separator 120 may be made of a polymer such as polyethylene PE or polypropylene (PP).

The electrodes 130 are respectively positioned respectively between the first separator members 111a, 111b, 111c, and 111d of the first separator 110 and the second separator members 121a, 121b, 121c, and 121d of the second separator 120 one by one. The electrodes 130 are arranged such that respective two neighboring electrodes 130 interpose first separator 110 or the second separator 120 therebetween and the centers thereof are positioned at the same position. By doing so, all of the electrodes 130 is exactly arranged perpendicular to the separator members 111a, 111b, 111c, 111d, 121a, 121b, 121c, and 121d. A central electrode member 140a positioned between the first separator member 111a positioned innermost the first separator 110 and the second separator member 121a positioned innermost the second separator 120 is attached to the inner surface 120a of the second separator member 121a, and the remaining electrodes 130 are attached to outer surfaces of the first separator members 111a, 111b, 111c, and 111d or outer surfaces 120b of the second separator members 121a, 121b, 121c, and 121d.

The electrodes 130 include a plurality of first electrode members 140a, 140b, 140c, 140d, and 140e and a plurality of second electrode members 150a, 150b, 150c, and 150d. The first electrode members 140a, 140b, 140c, 140d, and 140e and the second electrode members 150a, 150b, 150c, and 150d are alternatively positioned.

Each of the first electrode parts 140a, 140b, 140c, 140d, and 140e includes a positive electrode plate 141. The positive electrode plate 141 includes a positive electrode collector 142 and positive electrode active materials 143 coated on the both side of the positive electrode collector 142. The positive electrode collector 142 is generally made of an electrically conductive metal plate such as aluminum. The positive electrode collector 142 has a positive electrode tab 142a protruded outwardly without the positive electrode active material 143. The positive electrode tab 142a of the positive electrode plate 141 is welded to a positive terminal 160 protruded to the outside of the pouch case 20 by ultrasonic or resistance welding. The positive electrode active material 143 includes a layered lithium compound, an electrically conductive material to increase electric conductivity, and a binder to increase a binding force between the layered compound and the conductive material.

Each of the second electrode members 150a, 150b, 150c, and 150d has a negative electrode plate 151. The negative electrode plate 151 includes a negative electrode collector 152 and negative electrode active materials 153 coated on both sides of the negative electrode collector 152. The negative electrode collector 152 is generally made of an electrically conductive metal plate such as copper. The negative electrode collector 152 has a negative electrode tab 152a protruded outwardly without the negative electrode active material 153. The negative electrode tab 152a of the respective negative electrode plates 151 is welded to a negative terminal 170 protruded to the outside of the pouch case 20 by ultrasonic or resistance welding. The negative electrode active material 153 is prepared by mixing a carbon material such as graphite and a binder to increase a binding force between carbon particles. In this case, the positive electrode plate may have an area smaller than that of the negative electrode plate. Further, when tin oxide (SnO) or lithium titanium oxide (LTO) is used as the negative electrode active material, the corresponding positive electrode plate may have an area larger than that of the negative electrode plate.

FIG. 3 shows a process for manufacturing of the electrode assembly in FIG. 2. Referring to FIG. 3, the first separator 110 and the second separator 120 are respectively fed from the opposite sides of a winding position P.

The first separator 110 is fed from left to right toward the winding position P when viewing the drawing. The first separator 110 has an inner surface 110a becoming the inside by winding and an outer surface 110b becoming an outer side opposite to the inner surface 110a by winding. The first separator 110 includes the electrodes 130 attached thereto. The electrodes 130 attached to the first separator 110 are respectively positioned on the outer surface 110b of the first separator 110 to be spaced apart from each other in the feeding direction of the first separator 110. First electrode members 140b and 140d and second electrode members 150a and 150c of the first electrodes 130 are alternatively positioned on the outer surface 110b of the first separator 110. In this embodiment of the present invention, the electrode member 150a, which is positioned on a firstly winding portion 110e of the electrodes 130 attached to the outer surface 110b of the first separator 110, becomes a second electrode member but the present invention is not limited thereto. The electrode member 150a may be a first electrode member.

The second separator 120 is fed from right to left toward the winding position P when viewing the drawing. The second separator 120 has an inner surface 120a becoming the inside by winding and an outer surface 120b becoming an outer side opposite to the inner surface 120a by winding. The second separator 120 includes a plurality of electrode members 130 attached thereto. The electrodes 130 attached to the second separator 120 are respectively positioned on the outer surface 120b of the second separator 120 to be spaced apart from each other in the feeding direction of the second separator 120. First electrode members 140c and 140e and second electrode members 150b and 150d of the electrodes 130 are alternatively positioned on the outer surface 120b of the second separator 120. In this embodiment of the present invention, the electrode member 150b, which is positioned on a firstly winding portion 120e of the electrodes 130 attached to the outer surface 120b of the second separator 120, becomes a second electrode member having the same polarity as that of the electrode member 150a. A central electrode member 140a is attached to the inner surface 120a of the second separator 120. The central electrode member 140a is positioned on the firstly winding portion 120e of the second separator to correspond to the second electrode part 150b. The central electrode member 140a becomes the first electrode member having polarity opposite to the polarity of the second electrode member 150b.

Before the winding, the first electrode member 150a is positioned above the central electrode member 140a at the winding position P by interposing the first separator 110 therebetween. By doing so, the first electrode member 150a, the central electrode member 140a, and the second electrode member 150b are sequentially arranged between the first separator 110 and the second separator 120 in a stacked form, respectively. In this state, the first electrode member 150a, the central electrode member 140a, and the second electrode member 150b are gripped and wound to form the electrode assembly 100 as shown in FIG. 2. The electrode members 150a, 140a, and 150b are wound in the direction such that the electrode members 140b, 140c, 140d, 140e, 150a, 150b, 150c, and 150d except for the central electrode member 140a are positioned outside. The electrodes 130 may be fed during the winding, and the distance between the electrodes 130 may be easily adjusted to exactly arrange the electrodes 130 during the winding. In other words, as the winding is performing, the electrodes 130 are fed to the separators 110 and 120 such that the distance between the electrodes 130 is gradually increased. Thus, the electrodes 130 may be arranged at exact positions.

First and second electrodes according to another embodiment of the present invention are illustrated in FIGS. 4A and 4B, respectively.

Referring to FIG. 4A, a first electrode 240 includes two positive electrode plates 241 and 242, a single negative electrode plate 243 positioned between the positive electrode plates 241 and 242, and two separators 244 and 245 respectively positioned between the negative electrode plate 243 and the positive electrode plates 241 and 242. Since the two positive electrode plates 241 and 242 are identical to the positive electrode plate 141 as shown in FIG. 2 and the negative electrode plate 243 is identical to the negative electrode plate 151 as shown in FIG. 2, the detailed description thereof will be omitted. Fine porosities are formed in the separators 244 and 245, and lithium ions migrating between the electrode plates 241, 242, and 243 pass through the fine porosities. The separators 244 and 245 are made of a polymer such as polyethylene (PE) or polypropylene (PP).

Referring to FIG. 4B, the second electrode 250 includes two negative electrode plates 251 and 252, a positive electrode plate 253 positioned between the negative electrode plates 251 and 252, and two separators 254 and 255 respectively positioned between the positive electrode plate 253 and the two negative electrode plates 251 and 252. Since the negative electrode plates 251 and 252 are identical to the negative electrode plate 151 as shown in FIG. 2 and the positive electrode plate 253 is identical to the positive electrode plate 141 as shown in FIG. 2, the detailed description thereof will be omitted. Fine porosities are formed in the separators 254 and 255, and lithium ions migrating between the electrode plates 251, 252, and 253 pass through the fine porosities. The separator 254 and 255 are made of a polymer such as polyethylene (PE) or polypropylene (PP).

In the embodiment of FIGS. 4A and 4B, each of the first and second electrodes are made of three electrode plates, but the present invention is not limited thereto. The first and second electrodes may be made of more electrode plates. Any structure in which electrode plates having different polarities are alternatively positioned and another electrode plates having the same polarity are positioned at both sides of the alternatively positioned electrode plate may be allowed.

FIG. 5 is a schematic view illustrating an electrode assembly according to another embodiment of the present invention. Referring to FIG. 5, an electrode assembly 300 includes a first separator 310, a second separator 320, and a plurality of electrode members 330a, 330b, 330c, 330d, 330e, 330f, 330g, 330h, and 330i.

Since structures and functions of the first separator 310 and the second separator 320 are identical to those of the first separator 110 and the second separator 120, their detailed description will be omitted.

The electrode members 330a, 330b, 330c, 330d, 330e, 330f, 330g, 330h, and 330i are respectively positioned between the first separators 311a, 311b, 311c, and 311d and the second separators 321a, 321b, 321c, and 321d one by one. Two neighboring electrode members of the electrode members 330a, 330b, 330c, 330d, 330e, 330f, 330g, 330h, and 330i are arranged at the same position to interpose the first separator 310 and the second separator 320. A central electrode member 330a of the electrode members 330a, 330b, 330c, 330d, 330e, 330f, 330g, 330h, and 330i which is positioned between a first separator member 311a positioned at the innermost portion side of the first separator 310 and a second separator member 321a positioned at the innermost side of the second separator 320, is attached to an inner surface 320a of the second separator member 321a, and the other electrode members 330b, 330c, 330d, 330e, 330f, 330g, 330h, and 330i, except for the central electrode member 330a, is attached to outer surfaces 310b of the first separator members 311a, 311b, 311c, and 311d, or outer surfaces 320b of the second separator members 321a, 321b, 321c, and 321d.

Each of the electrode members 330a, 330b, 330c, 330d, 330e, 330f, 330g, 330h, and 330i includes a positive electrode plate 332, a negative electrode plate 333, and a separator 331 positioned between the electrode plates 332 and 333. Fine porosities are formed in the separator 331 through which lithium ions migrating between the electrode plates 332 and 333 pass. The separator 331 may be made of a polymer such as polyethylene PE or polypropylene (PP). The positive electrode plates 332 is identical to the positive electrode plate 141 as shown in FIG. 2, and the negative electrode plate 333 is identical to the negative electrode plate 151 as shown in FIG. 2. Thus, the detailed description thereof will be omitted. The electrode members 330a, 330b, 330c, 330d, 330e, 330f, 330g, 330h, and 330i are formed such that electrode plates having different polarities face each other by interposing the first separators 310 or the second separators 320 therebetween.

A process of manufacturing the electrode assembly as shown in FIG. 5 is illustrated in FIG. 6. Referring to FIG. 6, the first separator 310 and the second separator 320 are respectively fed from the opposite sides of the winding position P to the winding position P.

The first separator 310 is fed from left to right toward the winding position P when viewing the drawing. The first separator 310 has an inner surface 310a becoming the inside by winding and an outer surface 310b becoming an outer side opposite to the inner surface 310a by winding. The first separator 310 includes the electrode members 330b, 330d, and 330f attached thereto. The electrode members 330b, 330d, and 330f attached to the first separator 310 are respectively positioned on the outer surface 310b of the first separator 310 to be spaced apart from each other in the feeding direction of the first separator 310. The electrode members 330b, 330d, and 330f are attached to the outer surface 310b of the first separator 310 such that surfaces of the electrode members 330b, 330d, and 330f having opposite polarities alternatively contact the first electrode 310. In this embodiment of the present invention, a negative electrode plate 333b of the electrode member 330b, which is positioned on the firstly winding portion 310e among a plurality of electrode parts 330b, 330d, and 330f attached to the outer surface 310b of the first separator 310, contacts the first separator 310, but the present invention is not limited thereto. A positive electrode plate 332b of the first electrode part 330b may contact the first separator 310.

The second separator 320 is fed from right to left toward the winding position P when viewing the drawing. The second separator 320 has an inner surface 320a becoming an inside 320a by winding and an outer surface 320b becoming an outer side opposite to the inner surface 320a by winding. A plurality of electrode parts 320c, 320e, and 320g are attached to the second separator 320. The electrode members 320c, 320e, and 320g attached to the second separator 320 are respectively positioned on the outer surface 320b of the second separator 320 to be spaced apart from each other in the feeding direction of the second separator 320. The electrode members 320c, 320e, and 320g are attached to the outer surface 320b of the second separator 320 such that surfaces of the electrode members 320c, 320e, and 320g having different polarities alternatively contact the first separator 320. In this embodiment of the present invention, a positive electrode plate 332c of the electrode part 330c, which is positioned on the firstly winding portion 320e among a plurality of electrode members 320c, 320e, and 320g on the outer surface 320b of the second separator 320 contacts the second separator 320. A central electrode member 330a is attached to the inner surface 320a of the second separator 320. The central electrode member 330a is positioned on the firstly winding portion 320e of the second separator 320 to correspond to the second electrode member 330c. A negative electrode plate 333a of the central electrode member 330a contacts the second separator 320 so that each of the negative electrode plate 333a of the central electrode member 330a and the positive electrode plate 332c of the second electrode member 330c face each side by interposing the second separator 320 therebetween.

Before the winding, the electrode member 330b is positioned above the central electrode member 330a at the winding position P by interposing the first separator 310 therebetween. By doing so, the electrode member 330b, the central electrode member 330a, and the electrode member 330c are sequentially arranged between the first separator 310 and the second separator 320 in a stacked form, respectively. In this state, the electrode member 330b, the central electrode member 330a, and the electrode member 330c are gripped and wound to form the electrode assembly 300 as shown in FIG. 5. The winding is carried out in the direction where the electrode members 330b, 330c, 330d, 330e, 330f, 330g, 330h, and 330i except for the central electrode member 330a are positioned outside. The other structures and functions are the same as those of the embodiment in FIGS. 2 and 3.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

### BRIEF DESCRIPTION OF THE DRAWINGS

FIG. 1 is a perspective view illustrating a secondary battery according to an embodiment of the present invention;

FIG. 2 is a schematic view illustrating an electrode assembly in FIG. 1;

FIG. 3 is a view illustrating a manufacturing process of the electrode assembly in FIG. 2;

FIG. 4A is a schematic view illustrating a first electrode member of the electrode assembly as shown in FIG. 2 according to another embodiment of the present invention;

FIG. 4B is a schematic view illustrating a second electrode member of the electrode assembly as shown in FIG. 2 according to another embodiment of the present invention;

FIG. 5 is a schematic view illustrating the secondary battery in FIG. 1 according to another embodiment of the present invention; and

FIG. 6 is a view illustrating a manufacturing process of the secondary battery in FIG. 5.

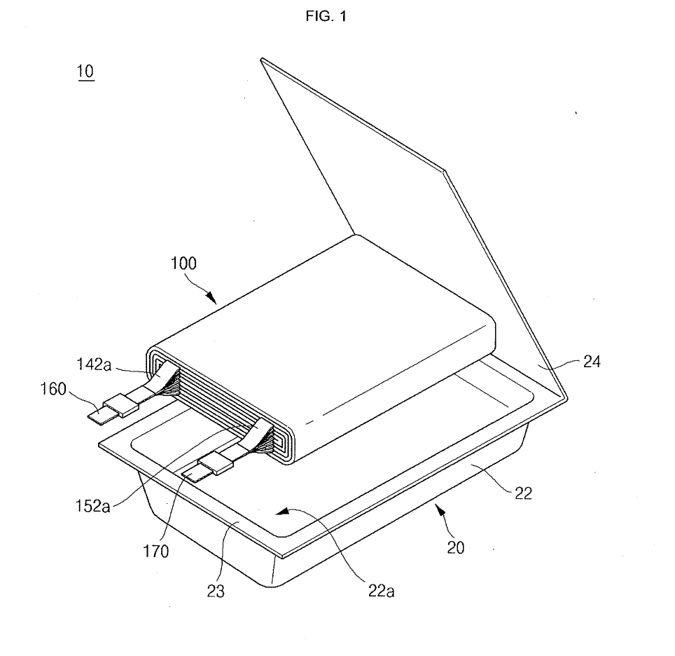

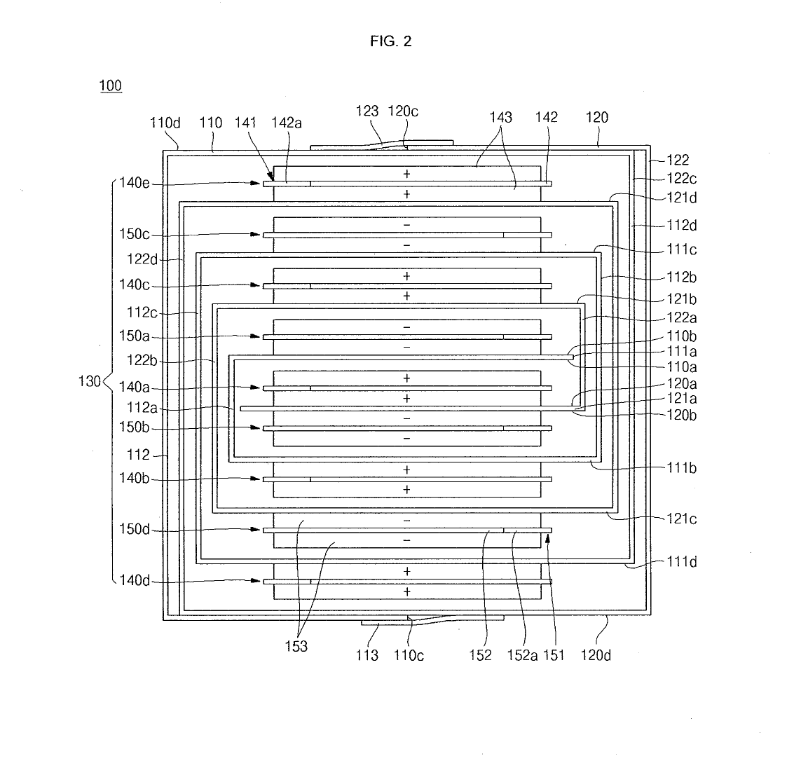

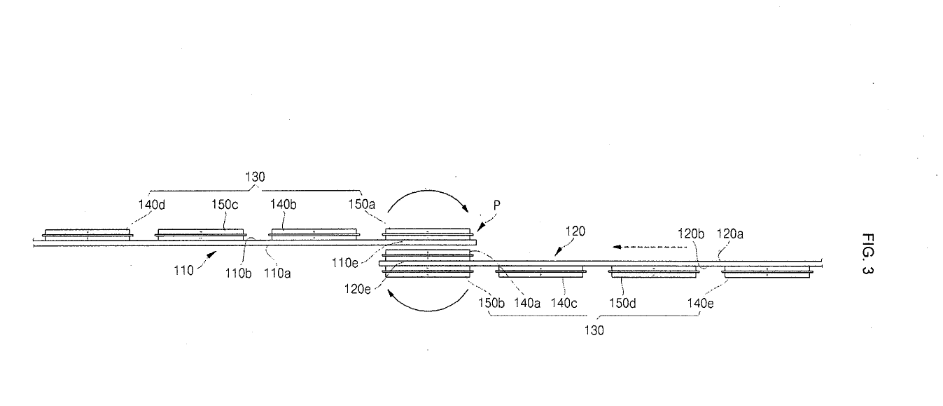

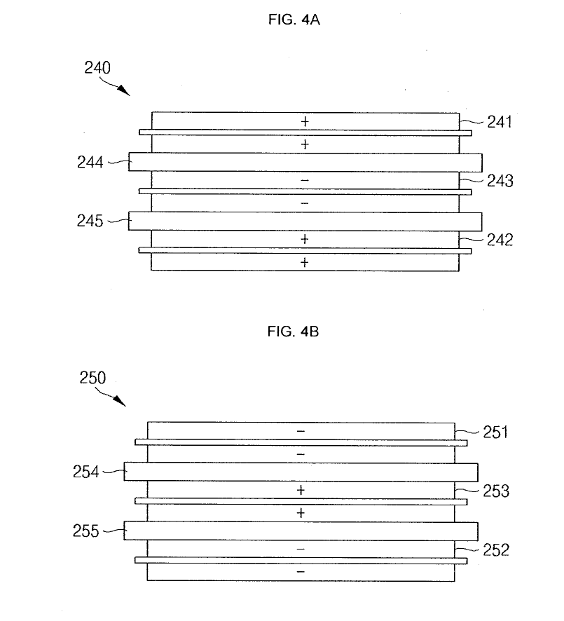

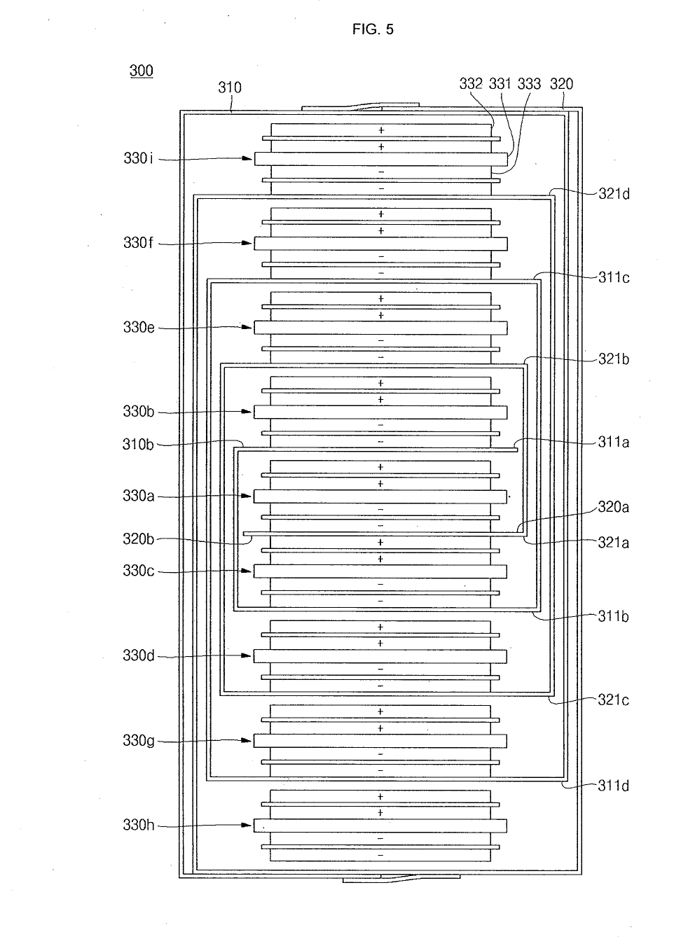

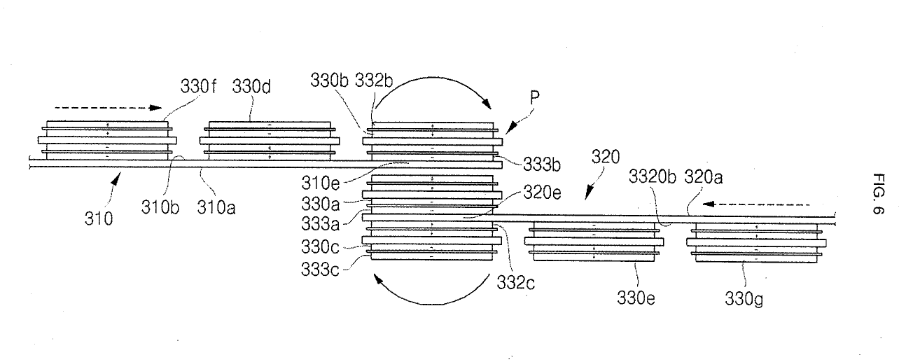

### DESCRIPTION OF THE SYMBOLS IN MAIN PORTIONS OF THE DRAWINGS

10: Secondary battery 100: Electrode assembly
110: first separator 120: second separator

What is claimed is:

1. An electrode assembly for a battery comprising:
a plurality of first electrodes;
a plurality of second electrodes wherein the plurality of first electrodes and the plurality of second electrodes are arranged into an alternating stack of electrodes;
a first separator that is wound through the alternating stack of electrodes so that the first separator is interposed between adjacent first and second electrodes; and
a second separator that is wound through the stack of electrodes so that the second separator is interposed between adjacent second and first electrodes and so that the second separator is interposed between adjacent portions of the first separator that are interposed between the adjacent first and second electrodes.

2. The assembly of claim 1, wherein the first separator defines a plurality of stacked first separator members and the second separator defines a plurality of stacked second separator members and wherein the first and second stacked separator members are alternately interposed between first and second electrodes within the stack of electrodes.

3. The assembly of claim 2, wherein an inner surface of one of the first separator members positioned at the innermost side of the electrode assembly and an inner surface of one of the second separator members positioned at the innermost side of the electrode assembly face each other.

4. The assembly of claim 1, wherein the electrode stack is assembled to define an innermost region and wherein the first and second separators have an inner surface and an inner and outer end and wherein the inner surface of the first separator is positioned at the innermost region of the electrode assembly and the inner surface of the second separator is positioned at the innermost region of the electrode assembly so that the inner surfaces of the first and second separators face each other.

5. The assembly of claim 4, wherein the inner end of both the first and second separators are positioned at the innermost region of the electrode stack.

6. The assembly of claim 1, wherein the first electrode comprises a positive electrode plate and the second electrode comprises a negative electrode plate.

7. The assembly of claim 1, wherein the first electrode and second electrodes are comprised of a plurality of electrode plates that are separated by discrete separators.

8. The assembly of claim 7, wherein the first electrode comprise a first and a second positive electrode plates and a negative electrode plate that is interposed between the first and second positive electrode plates wherein the discrete separators are interposed between the first and second positive electrode plates and the negative electrode plates.

9. The assembly of claim 7, wherein the second electrodes comprise a first and a second negative electrode plates and a positive electrode plate that is interposed between the first and second negative electrode plates wherein the discrete separators are interposed between the first and second negative electrode plates and the positive electrode plates.

10. The assembly of claim 7, wherein the first and second electrodes each comprise a positive electrode plate and a negative electrode plate with a discrete separator interposed therebetween.

11. The assembly of claim 1, wherein the first electrode comprises a positive electrode plate having a first and a second side wherein the positive electrode plate defines an electrode collector and wherein the first and the second side of the positive electrode plate are coated with a positive electrode active material.

12. The assembly of claim 1, wherein the second electrode comprises a negative electrode plate having a first and a second side wherein the negative electrode plate defines an electrode collector and wherein the first and the second side of the negative electrode plate are coated with a negative electrode active material.

13. The assembly of claim 1, wherein the first separator is a continuous piece of material that is wound about the stack of electrodes in a first direction and the second separator is a continuous piece of material that is wound about the stack of electrodes in a first direction.

14. A method of forming an electrode assembly having an innermost region, comprising:
feeding a first separator towards a winding center from a first side beginning with an inner end;
feeding a second separator towards the winding center from a second side beginning with an inner end;
winding the first and second separators together so the first ends of the first and second separator are positioned within the innermost region of the electrode assembly.

15. The method of claim 14, further comprising:
positioning first electrodes on the first separator;
positioning second electrodes on the second separator wherein winding the first and second separators results in the first and second separators being alternately interposed between the first and second electrodes.

16. The method of claim 15, wherein the first and second electrodes are respectively positioned on the first and second separators before winding.

17. The method of claim 14, wherein winding the first and second separators together comprises winding the first and second separators so that an inner surface of the first and an inner surface of the second separator are both positioned at the innermost region of the electrode assembly and so that the inner surfaces of the first and second separators face each other.

18. The method of claim 17, wherein positioning a plurality of electrodes on the first and second continuous separators comprises positioning positive electrodes on the first separator and negative electrodes on the second separators.

19. The method of claim 15, wherein positioning the first electrode and second electrodes on the first and second separators comprises positioning electrodes comprised of a plurality of electrode plates that are separated by discrete separators on the first and second separators.

20. The method of claim 19, wherein the first, electrode comprise a first and a second positive electrode plates and a negative electrode plate that is interposed between the first and second positive electrode plates wherein the discrete separators are interposed between the first and second positive electrode plates and the negative electrode plates.

21. The method of claim 20, wherein the second electrodes comprise a first and a second negative electrode plates and a positive electrode plate that is interposed between the first and second negative electrode plates wherein the discrete separators are interposed between the first and second negative electrode plates and the positive electrode plates.

22. The method of claim 19, wherein the first and second electrodes each comprise a positive electrode plate and a negative electrode plate with a discrete separator interposed therebetween.

23. The method of claim 15, wherein the electrodes are positioned on the separators so that adjacent electrodes on the separators are spaced further apart from each other, the further the electrodes are positioned from the inner ends of the separators.
